(19) United States
(12) Patent Application Publication
(10) Pub. No.: US 2015/0042805 A1
(43) Pub. Date: Feb. 12, 2015

(54) DETECTING DEVICE, DETECTION METHOD, AND COMPUTER PROGRAM PRODUCT

(71) Applicant: KABUSHIKI KAISHA TOSHIBA, Tokyo (JP)

(72) Inventors: Mayu OKUMURA, Kawasaki (JP); Tomoki WATANABE, Tokyo (JP)

(21) Appl. No.: 14/452,668

(22) Filed: Aug. 6, 2014

(30) Foreign Application Priority Data
Aug. 8, 2013 (JP) 2013-165377

(51) Int. Cl. G06T 5/00; B60R 11/04; G01B 11/28

(52) U.S. Cl. CPC G06T 5/003; G01B 11/28; B60R 11/04
USPC 348/148

(57) ABSTRACT

According to an embodiment, a detecting device is mounted on a moving object. The detecting device includes an image acquiring unit, an operation information acquiring unit, a setting unit, and a detector. The image acquiring unit is configured to acquire an image. The operation information acquiring unit is configured to acquire an operation in the moving object. The operation affects the image. The setting unit is configured to set a parameter based on the operation. The detector is configured to detect an object area from the image by performing a detection process in accordance with the set parameter.

### CROSS-REFERENCE TO RELATED APPLICATION

This application is based upon and claims the benefit of priority from Japanese Patent Application No. 2013-165377, filed on Aug. 8, 2013; the entire contents of which are incorporated herein by reference.

### FIELD

Embodiments described herein relate generally to a detecting device, a detection method, and a computer program product.

### BACKGROUND

Systems for assist drivers by detecting pedestrians and obstacles from the images captured by an onboard camera have been developed. The features of images captured by a camera can vary greatly, depending on the conditions of the outer environment such as weather and time of a day (e.g., daytime or nighttime).

A technology developed to address this issue uses an external sensor to detect the conditions of the outer environment, and switches the models for detecting pedestrians and obstacles to those suitable for the outer environment conditions based on the detection result. This technology uses an external sensor such as a luminometer to make measurements of the outer environment conditions, and switches the detection models between the time periods of a day causing the image features to change by a large degree, e.g., the daytime and nighttime, using the measurement result. When the detection models are switched based on a change in the measurement of the outer environment conditions, the resultant detection becomes less inaccurate, even when the outer environment conditions change and the image features change accordingly.

Although such a conventional technology can accommodate with a change in the outer environment conditions because an external sensor is used to measure the outer environment conditions, it has been difficult to cope with a change in the image features caused by operations within the vehicle, which are not dependent on the outer environment conditions.

### BRIEF DESCRIPTION OF THE DRAWINGS

FIG. 1 is a block diagram illustrating an exemplary configuration of a vehicle control system in which a detecting device according to a first embodiment can be used;

FIG. 2 is a functional block diagram illustrating exemplary functions of the detecting device according to the first embodiment;

FIG. 3 is a schematic of an example how cameras are installed in an ego-vehicle;

FIG. 4 is a flowchart illustrating an exemplary object detection process performed by the detecting device according to the first embodiment;

FIG. 5 is a schematic for explaining a detection window set to a captured image in the first embodiment;

FIG. 6 is a flowchart illustrating an exemplary detection process performed by a detecting device according to the first embodiment;

FIG. 7 is a schematic of an exemplary detection parameter table according to the first embodiment;

FIG. 8 is a flowchart illustrating an exemplary object detection process performed by the detecting device according to the first embodiment;

FIG. 9 is a schematic for explaining gamma correction;

FIG. 10 is a flowchart illustrating an exemplary object detection process performed by the detecting device according to the first embodiment;

FIG. 11 is a schematic for explaining a mask area set to a detection window area according to the first embodiment;

FIG. 12 illustrates how the mask area is set based on the position of a wiper arm in the first embodiment;

FIG. 13 is a schematic illustrating the distance between the front lens of the camera and the windshield when the camera is installed on the ceiling and the dashboard;

FIG. 14 is a schematic for explaining how rain drop images are captured in a captured image when rain drops are on the windshield;

FIG. 15 is a flowchart illustrating an exemplary object detection process performed by the detecting device according to the first embodiment;

FIG. 16 is a schematic for explaining radial motion blur;

FIG. 17 is a flowchart illustrating an exemplary object detection process performed by the detecting device according to the first embodiment;

FIG. 18 is a flowchart illustrating an exemplary object detection process performed by the detecting device according to the first embodiment;

FIG. 19 is a flowchart illustrating an exemplary object detection process performed by the detecting device according to the first embodiment;

FIG. 20 is a flowchart illustrating an exemplary object detection process performed by the detecting device according to the first embodiment;

FIG. 21 is a functional block diagram of exemplary functions of a detecting device according to a second embodiment;

FIG. 22 is a schematic of an exemplary detection parameter table according to the second embodiment;

FIG. 23 is a schematic for explaining a target area according to the second embodiment; and

FIG. 24 is a schematic for explaining how a plurality of target areas can overlap each other in the second embodiment.

### DETAILED DESCRIPTION

According to an embodiment, a detecting device is mounted on a moving object. The detecting device includes an image acquiring unit, an operation information acquiring unit, a setting unit, and a detector. The image acquiring unit is configured to acquire an image. The operation information acquiring unit is configured to acquire an operation in the moving object. The operation affects the image. The setting unit is configured to set a parameter based on the operation. The detector is configured to detect an object area from the image by performing a detection process in accordance with the set parameter.

Configuration According to First Embodiment

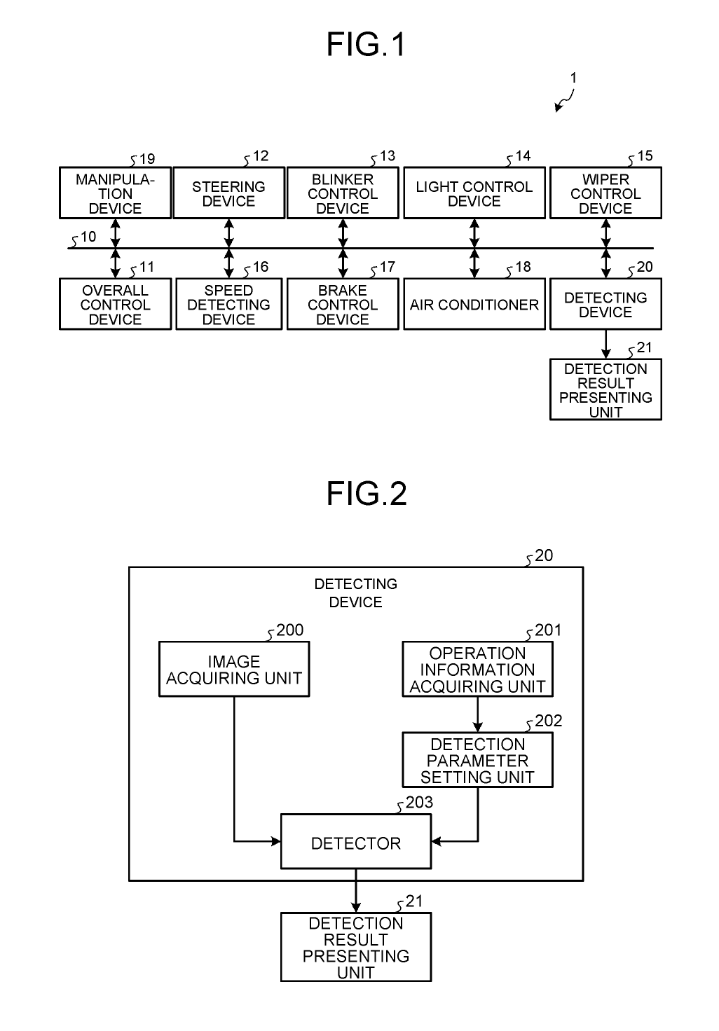

A detecting device, a detection method, and a detection program according to a first embodiment will now be explained. FIG. 1 illustrates an exemplary configuration of a control system for controlling the movement of a moving object, the control system for which the detecting device according to the first embodiment can be used.

In the example illustrated in FIG. 1, it is assumed that the moving object is a vehicle, and this control system 1 includes a bus 10, an overall control device 11, a steering device 12, a blinker control device 13, a light control device 14, a wiper control device 15, a speed detecting device 16, a brake control device 17, an air conditioner 18, a manipulation device 19, and a detecting device 20. The steering device 12, the blinker control device 13, the light control device 14, the wiper control device 15, the speed detecting device 16, the brake control device 17, the air conditioner 18, the manipulation device 19, and the detecting device 20 are communicatively connected to the overall control device 11 via the bus 10. In the description hereunder, the vehicle of which movement is controlled by the control system 1 will be referred to as an ego-vehicle.

The manipulation device 19 includes manipulandums for causing the parts of the vehicle to operate, and examples of which include a steering wheel, a brake pedal, a light switch, a wiper switch, a blinker switch, and an air conditioner operation switch, none of which are illustrated. When the driver or the like operates one of such manipulandums, the manipulation device 19 receives the operation signal from the manipulandum, and outputs the operation signal to the overall control device 11.

The overall control device 11 includes, for example, a central processing unit (CPU), a read-only memory (ROM), a random access memory (RAM), and a communication interface (I/F), and controls the devices connected to the bus 10, in accordance with a computer program stored in the ROM in advance, using the RAM as a working memory. The communication I/F serves as an interface via which signals are exchanged among the CPU and the devices connected to the bus 10.

Under control of the overall control device 11 based on the an operation performed on the steering wheel, the steering device 12 drives the steering mechanism of the vehicle, and the travelling direction of the vehicle is changed accordingly. Based on an operation performed on the blinker operation switch, the overall control device 11 causes the blinker control device 13 to turn on or off the left or right blinkers. Under control of the overall control device 11 based on an operation performed on the light operation switch, the light control device 14 turns on or off the headlights and switches the directions illuminated by the lights (bright or dim).

Under control of the overall control device 11 based on an operation performed on the wiper operation switch, the wiper control device 15 turns on or off the wipers, and changes the speed of the wiper arms while the wipers are operating. The wiper control device 15 causes the wiper arms to be reciprocated at a constant interval, at a set speed under the control of the overall control device 11.

The speed detecting device 16 includes a speed sensor installed in the transmission, for example, and detects the travelling speed of the vehicle based on an output from the speed sensor. The speed detecting device 16 transmits information indicating the detected travelling speed to the overall control device 11. Detection of the travelling speed is not limited thereto, and the speed detecting device 16 may also transmit an output from the speed sensor to the overall control device 11, and the overall control device 11 may be caused to detect the travelling speed based on the output of the speed sensor. The brake control device 17 drives the brakes by a braking amount that is based on the control of the overall control device 11 performed based on an operation of the brake pedal.

Under control of the overall control device 11 based on an operation performed on the air conditioner operation switch, the air conditioner 18 functions as a cooler, heater, or ventilator and defrosts or demists the windshield, for example.

The detecting device 20 according to the first embodiment captures, for example, the image in front of the vehicle with a camera installed on the vehicle, and detects an area corresponding to a predetermined object, such as a person or an obstacle, in the captured image. A detection result presenting unit 21 includes a display such as a liquid crystal display (LCD), and presents information such as that of a person or an obstacle found in front of the ego-vehicle based on the detection result from the detecting device 20.

“Operation” as used hereinafter is intended to encompass such terms “operating”, “action”, “behavior”, or “actuation”. The detecting device 20 also acquires information related to an operation performed in the ego-vehicle from the overall control device 11, for example, and sets detection parameters based on the operation of which information is thus acquired. The detecting device 20 then detects the area corresponding to an object from the captured image using the set detection parameters. In this manner, the detecting device 20 can detect the object area from the captured image while taking the operations in the ego-vehicle into account in the first embodiment, so that the detecting device 20 can detect the object area from the captured image more accurately.

FIG. 2 is a functional block diagram illustrating exemplary functions of the detecting device 20 according to the first embodiment. The detecting device 20 includes an image acquiring unit 200, an operation information acquiring unit 201, a detection parameter setting unit 202, and a detector 203. Each of the image acquiring unit 200, the operation information acquiring unit 201, the detection parameter setting unit 202, and the detector 203 may be implemented on a corresponding piece of hardware, or may be implemented partly or entirely as a computer program running on the CPU.

The image acquiring unit 200 acquires an image of outside of the ego-vehicle, e.g., a moving image captured by a camera installed on the ego-vehicle.

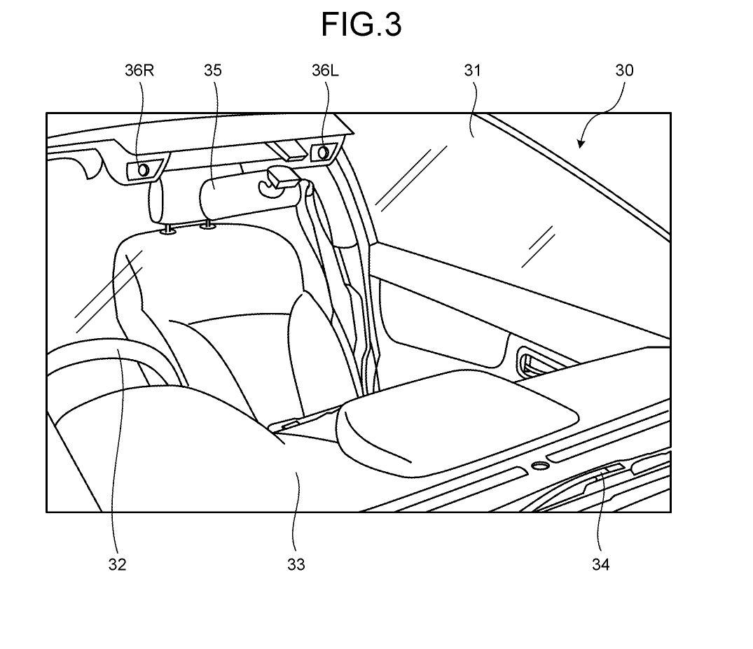

FIG. 3 illustrates an example how the camera is installed on the ego-vehicle. In the example illustrated in FIG. 3, a windshield 31 in the body 30 of the ego-vehicle serves as a partition between the areas inside and outside of the vehicle. Inside of the vehicle, a dashboard 33 and a steering wheel 32 are provided nearer to the driver with respect to the windshield 31. Outside of the vehicle, wiper arms 34 are provided at the bottom of the windshield 31. In the example illustrated in FIG. 3, a rearview mirror 35 is mounted on the windshield 31.

Cameras 36R and 36L are provided to the ceiling inside of the vehicle so as to capture the image in front of the body 30. In the example illustrated in FIG. 3, because the cameras 36R and 36L are provided inside of the vehicle, the cameras 36R and 36L capture images of outside through the windshield 31.

The cameras 36R and 36L together function as what is called a stereo camera, and capable of capturing two images of which field of views are offset from each other by a predetermined distance in the horizontal direction. In the first embodiment, the cameras for allowing the image acquiring unit 200 to acquire the images may be a monocular camera, without limitation to a stereo camera. In the description hereunder, the image captured by the camera 36R is used, among those captured by the two cameras 36R and 36L. The image acquiring unit 200 acquires an image captured by the camera 36R, and sends the image to the detector 203.

The camera 36R may capture the images of the left and the right sides of the body 30 or the image of the rear side of the body 30, without limitation to the image of the front side of the body 30 as illustrated in the example in FIG. 3. Furthermore, explained herein is an example in which the camera 36R captures the images of light within the range of visible light, but the camera 36R may capture images of light outside of the range of visible light, e.g., light in the range of infrared, without limitation to the range of visible light.

The operation information acquiring unit 201 acquires information related to an operation performed in the ego-vehicle. The operation information acquiring unit 201 acquires operation information for operations that affect images captured by the camera 36R, among the operations done in the ego-vehicle. An operation is considered to affect images when two images captured successively in the temporal order by an image capturing device are compared, and these images are found to represent different features because of the operation. The images to be compared may also be separated by a several frames, for example. The operation information acquiring unit 201 acquires the operation information from, for example, at least one of the steering device 12, the blinker control device 13, the light control device 14, the wiper control device 15, the speed detecting device 16, the brake control device 17, and the air conditioner 18, via the overall control device 11.

The detection parameter setting unit 202 sets the detection parameters used by the detector 203 when the object area is detected from the captured image, based on the operation information acquired by the operation information acquiring unit 201. The detector 203 detects the object area from the captured image received from the image acquiring unit 200, in accordance with the detection parameters set by the detection parameter setting unit 202. The type of the objects, such as persons, traffic signs, and poles, is specified in advance. The detecting device 20 outputs the detection result of the detector 203 to the detection result presenting unit 21.

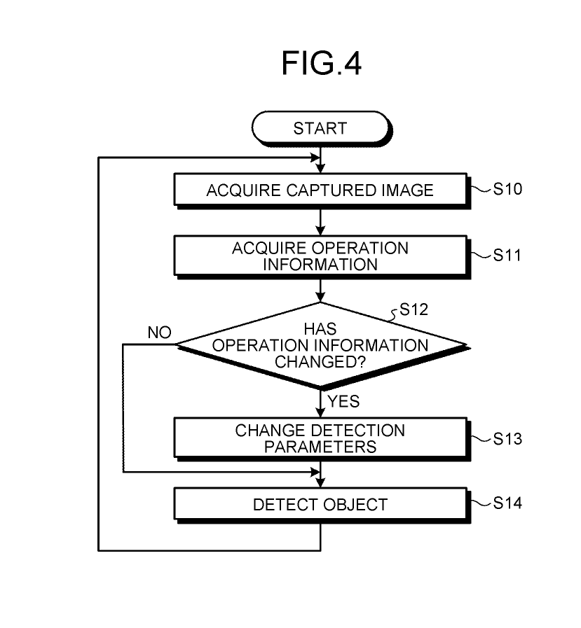

FIG. 4 is a flowchart illustrating an exemplary object detection process performed by the detecting device 20 according to the first embodiment. Before the process illustrated in the flowchart of FIG. 4 is performed, an object to be detected from the captured image is specified in advance. In the description hereunder, the type of an object to be detected is explained to be persons, although the type is not particularly limited.

In the detecting device 20, the image acquiring unit 200 acquires an image captured by the camera 36R at Step S10, and sends the acquired captured image to the detector 203.

At the following Step S11, the operation information acquiring unit 201 acquires the operation information related to a predetermined operation in the ego-vehicle. The operation of which operation information is acquired by the operation information acquiring unit 201 is an operation that changes the captured image, or an operation before and after which a change occurs in the captured image, among those for which operation information can be acquired in the ego-vehicle.

At the following Step S12, the detection parameter setting unit 202 compares the operation information having just been acquired and the operation information of the same type previously acquired, and determines if the operation information has changed. If the detection parameter setting unit 202 determines that operation information has not changed, the detection parameter setting unit 202 shifts the processing to Step S14.

If the detection parameter setting unit 202 determines that the operation information has changed at Step S12, the detection parameter setting unit 202 shifts the processing to Step S13. At Step S13, the detection parameter setting unit 202 changes the detection parameters with which the object area is detected from the captured image by the detector 203, based on the operation information having just been acquired. The detection parameters, of which details will be described later, include a detection algorithm describing the steps of an object detection process performed to a captured image, a detection model indicating the type of the detection process, and a threshold used by the detection model when the object area is detected. The detection parameter setting unit 202 sets the changed detection parameters to the detector 203.

The detection parameter setting unit 202 stores the operation information having just been acquired in a memory or the like not illustrated. The stored operation information is used as the previous operation information when Step S12 is executed next time.

At the following Step S14, the detector 203 performs the object area detection process from the captured image acquired by and received from the image acquiring unit 200 at Step S10, in accordance with the set detection parameters. The detector 203 applies image processing to the captured image in accordance with the detection algorithm included in the detection parameters, and then detects an object area from the captured image. The detector 203 performs the object detection process based on the detection model and the threshold specified as the detection parameters.

If an object area is detected from the captured image as a result of the detection process performed at Step S14, the detector 203 outputs a piece of information indicating that the object is detected to the detection result presenting unit 21. The process then returns to Step S10.

Object Detection Process

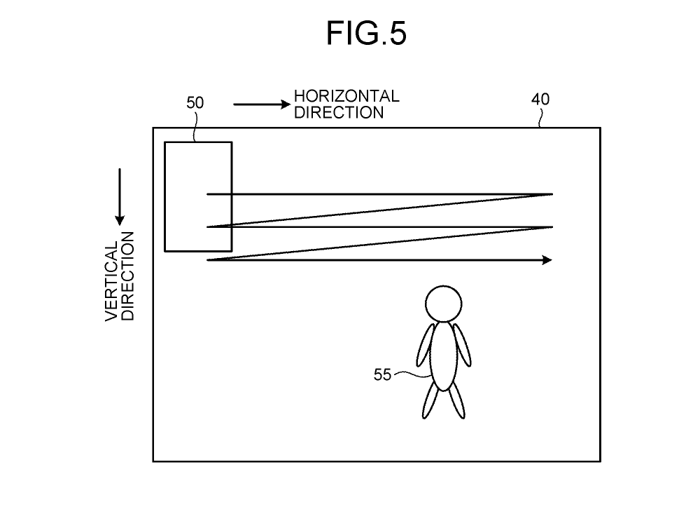

The object detection process performed at Step S14 will now be explained more in detail. As illustrated in FIG. 5, in the first embodiment, the detector 203 sets a detection window 50 of a predetermined size to a captured image 40 from which an object is to be detected. The detector 203 computes feature descriptors of the image within the detection window 50, while moving the detection window 50 in the horizontal direction in units of a predetermined distance, and in the vertical direction in units of a predetermined distance, for example, across the captured image 40, and determines if an area 55 corresponding to the object is included in the captured image 40 based on the computed feature descriptors.

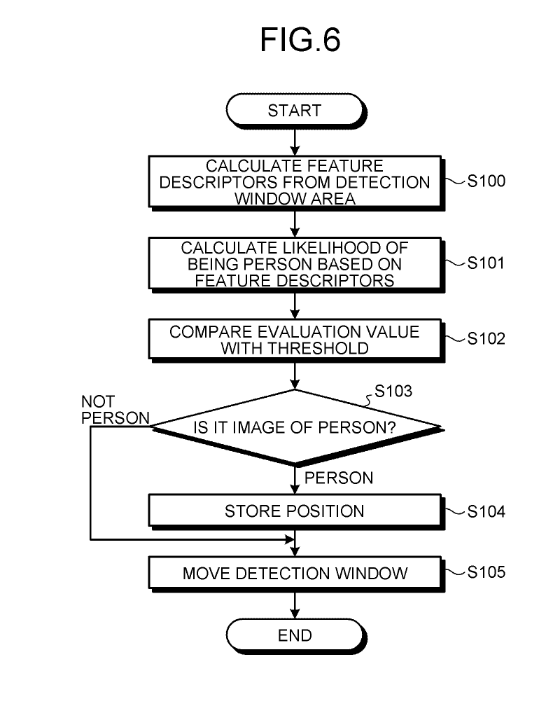

FIG. 6 is a flowchart illustrating an exemplary detection process performed by the detector 203 according to the first embodiment. In the embodiment, the object to be detected from the captured image 40 is explained to be persons.

At Step S100 in FIG. 6, the detector 203 computes the feature descriptors of the image in the detection window 50. The detector 203 may compute, as the feature descriptors, for example, histograms-of-oriented-gradients (HOG) feature descriptors that are the histograms of luminance gradients and intensities within the detection window 50.

At the following Step S101, the detector 203 computes an evaluation value of the likelihood of the detected area being a person with a classifier, based on the feature descriptors extracted at Step S100. The classifier may be, for example, a support vector machine (SVM) classifier suitably trained with HOG feature descriptors extracted from images with an object, images without the object, or images including a very small part of the object, for example. The evaluation value may be, for example, a distance of the feature descriptors computed at Step S100 to a maximum-margin hyperplane acquired by training.

The feature descriptors computed at Step S100 may be co-occurrence HOG (CoHOG) feature descriptors, which are HOG feature descriptors with an improved classification performance, described in Tomoki Watanabe, Satoshi Ito, and Kentaro Yokoi, “Co-occurrence Histograms of Oriented Gradients for Human Detection”, IPSJ Transactions on Computer Vision and Applications, Vol. 2, pp. 39-47 (2010). In other words, at Step S100, the detector 203 computes the directions of the luminance gradients in the image area of the detection window 50, and computes CoHOG feature descriptors from the computed gradient directions. The detector 203 then computes a distance of the computed CoHOG feature descriptors to the maximum-margin hyperplane as the evaluation value, using an SVM suitably trained with CoHOG feature descriptors extracted from images with an object, images without the object, and images including a very small part of the object.

At the following Step S102, the detector 203 compares the evaluation value computed at Step S101 with a threshold. The threshold is set to the detector 203 by the detection parameter setting unit 202 as a detection parameter.

At the following Step S103, the detector 203 determines if any object area is included in the image in the detection window 50, based on the comparison result at Step S102. The detector 203 determines that an object area is included in the image if the evaluation value exceeds the threshold, for example. If the detector 203 determines that any object area is not included in the image, the detector 203 shifts the processing to Step S105.

If the detector 203 determines that an object area is included in the image at Step S103, the detector 203 shifts the processing to Step S104, and stores the position of the object in the captured image 40 in memory or the like. Alternatively, the detector 203 may store the coordinate position of the detection window 50 having been determined to include the object in the captured image 40 at Step S104, without limitation to the position of the object area. Once the position of the object area is stored, the detector 203 shifts the processing to Step S105, and moves the detection window 50 in the captured image 40.

The detector 203 repeats Steps S10 to S14 illustrated in FIG. 4 while moving the detection window 50 at a predetermined interval. Once the detection window 50 reaches the last position in the captured image 40 (e.g., the lower right corner of the captured image 40) and the detector 203 completes detection of the object area at the final position, the detector 203 repeats Steps S10 to S14 on an upcoming frame of the captured image 40 by moving the detection window 50 across the frame.

Detection Parameters

The detection parameters according to the first embodiment will now be explained more in detail. As explained with reference to the flowchart in FIG. 4, the detecting device 20 acquires operation information for predetermined types of operations performed in the ego-vehicle, and when there is a change in the operation information, the detection parameters used by the detector 203 when the object is detected are changed. The detecting device 20 acquires the operation information for an operation that changes the captured image 40, and for an operation before and after which a change occurs in the captured image 40. In other words, the detecting device 20 acquires operation information for an operation causing the captured image 40 to appear differently before and after the operation is performed.

Examples of such operations changing the captured image 40 or before and after which a change occurs in the captured image 40 includes an operation of turning on or off the lights, an operation of switching the directions of the lights, an operation of causing the wipers to operate, an operation of driving the ego-vehicle, a braking operation with a brake, a steering operation, and an operation of turning on or off the blinkers.

The detecting device 20 may also acquire an operation of the air conditioner as an operation that changes the captured image 40, without limitation to the operations listed above. In other words, between the hot seasons and cold seasons, for example, one can expect to see different patterns of clothing, and, as the air conditioner is operated differently between these seasons, a change should appear in the captured image 40 accordingly.

At Step S11 in the flowchart illustrated in FIG. 4, the operation information acquiring unit 201 acquires the operation information of at least one of the operations changing the captured image 40, and the operations before and after which a change occurs in the captured image 40.

For the operation of turning on and off the light and the operation of switching the direction of the light, the operation information acquiring unit 201, for example, requests operation information indicating the operation from the overall control device 11. In response to the request, the overall control device 11 acquires the operation information indicating on or off of the light or the direction of the light from the light control device 14, and passes the operation information to the operation information acquiring unit 201. Similarly, for the wiper operation, the operation information acquiring unit 201, for example, requests operation information indicating the wiper operation from the overall control device 11. In response to the request, the overall control device 11 acquires the operation information indicating the wiper operation from the wiper control device 15, and passes the operation information to the operation information acquiring unit 201.

For the driving operations of the ego-vehicle, the operation information acquiring unit 201, for example, requests operation information indicating the operation from the overall control device 11. In response to the request, the overall control device 11 then acquires information indicating the travelling speed from the speed detecting device 16, and passes the travelling speed to the operation information acquiring unit 201, as the operation information indicating a driving operation. For a braking operation with a brake, the operation information acquiring unit 201, for example, requests operation information indicating the braking operation from the overall control device 11. In response to the request, the overall control device 11 acquires the information indicating a braking amount from the brake control device 17, and passes the braking amount information to the operation information acquiring unit 201, as the operation information indicating a braking operation.

For a steering operation, the operation information acquiring unit 201, for example, requests operation information indicating the operation from the overall control device 11. In response to the request, the overall control device 11 acquires the information indicating an angle of the steering wheel from the steering device 12, and passes the steering wheel angle information to the operation information acquiring unit 201, as the operation information indicating a steering operation. For an operation of turning on or off the blinkers, the operation information acquiring unit 201, for example, requests the operation information from the overall control device 11. In response to the request, the overall control device 11 acquires the information indicating on or off of the blinkers, and if the blinkers are on, the information indicating which of the left or right blinkers are on from the blinker control device 13, and passes the information to the operation information acquiring unit 201, as the operation information indicating on or off of the blinkers.

For an operation of the air conditioner 18 as well, the operation information acquiring unit 201 requests the information indicating the operation from the overall control device 11. In response to the request, the overall control device 11 acquires operation information such as on or off of the air conditioner, a temperature setting, or the amount of the air flow from the air conditioner 18, and passes the operation information to the operation information acquiring unit 201.

In the example explained above, the operation information acquiring unit 201 requests the operation information from the overall control device 11, but how the operation information is acquired is not limited thereto. The operation information acquiring unit 201 may, for example, acquire the operation information directly from the source units of the operation information, such as the steering device 12, the blinker control device 13, the light control device 14, the wiper control device 15, the speed detecting device 16, the brake control device 17, and the air conditioner 18.

Detection Parameter Table

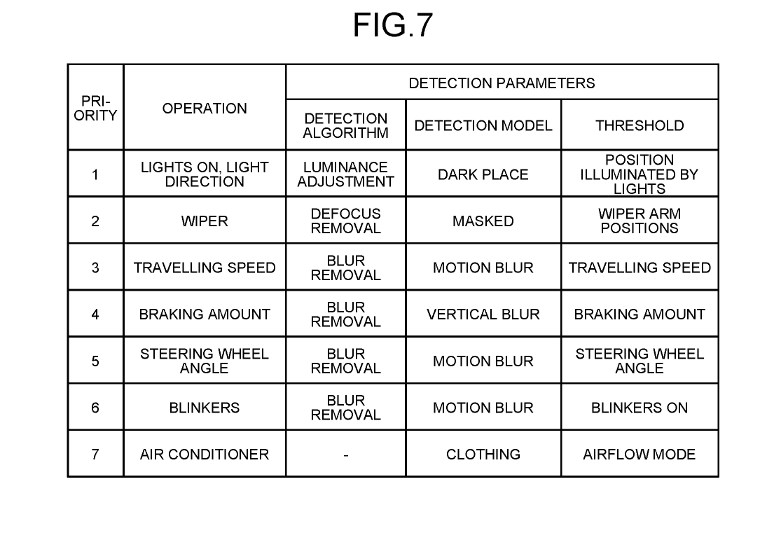

The detection parameter setting unit 202 stores the detection parameters corresponding to each of the operations in the memory or the like in advance, as a detection parameter table. FIG. 7 illustrates an exemplary detection parameter table according to the first embodiment. As illustrated in FIG. 7, the detection parameter table stores therein a type of the operations in a manner associated with detection parameters and priority. The detection parameters include a detection algorithm, a detection model, and a threshold, as mentioned earlier.

A detection algorithm, a detection model, a threshold, and priority are set to each type of operations as the detection parameters. In the example illustrated in FIG. 7, seven different types of operations, including (1) Lights On, Light Direction, (2) Wiper, (3) Travelling Speed, (4) Braking Amount, (5) Steering Wheel Angle, (6) Blinkers, and (7) Air Conditioner, are provided.

Each of these types of operations is associated with a detection algorithm and a detection model as the detection parameters. The threshold, which is one of the detection parameters, contains operation information to which the threshold is applied, and a threshold level corresponding to the operation information. In the example illustrated in FIG. 7, only the operation information to which the threshold is set is specified in the part of the threshold.

The (1) “Lights On, Light Direction”, among the operations listed above, indicates an operation of turning on or off of the lights, or switching the direction of the lights, and is associated with a detection algorithm “Luminance Adjustment” and a detection model “Dark Place model” as the detection parameters. It is also understood that the threshold is set as appropriate based on the positions illuminated by the lights.

More specifically, the “Luminance Adjustment” applied to the operation “Lights On, Light Direction” is a detection algorithm for detecting the object area after adjusting the luminance of the image. The Dark Place model represents a detection model that uses a classifier trained with images of dark places to detect the object area. The threshold is lowered at a position not illuminated by the lights based on the positions illuminated by the lights, so that the object area can be identified with a lower evaluation value than that in the area illuminated by the lights.

The (2) “Wiper”, among the operations listed above, represents an operation of turning on or off the wipers, and is associated with a detection algorithm “Defocus Removal” and a detection model “Masked model” as the detection parameters. It is also understood that the threshold is set as appropriate based on the positions of the wiper arms in the image.

More specifically, the “Defocus Removal” applied to the operation “Wiper” is a detection algorithm for detecting the object area after removing defocus from the captured image 40. The Masked model represents a detection model for detecting the object area using a classifier trained with images with a mask applied to a part of the detection window 50. The threshold is lowered in a predetermined area from and including the positions of the wiper arms in the image, so that the object can be identified with a lower evaluation value in the area near the wiper arms. The current positions (angles) of the wiper arms may be acquired, for example, from the overall control device 11 or the wiper control device 15.

The (3) “Travelling Speed”, among the operations listed above, represents a travelling speed of the ego-vehicle, and associated with a detection algorithm “Blur Removal” and a detection model “Motion Blur” as the detection parameters. It is also understood that the threshold is set as appropriate based on the travelling speed.

More specifically, the “Blur Removal” applied to the operation “Travelling Speed” is a detection algorithm for detecting the object area after removing blur from the captured image 40. The “Motion Blur” represents a detection model (referred to as a Motion Blur model) that detects an object area using a classifier trained with images with motion blur extending radially from the vanishing point of the captured image 40, which is blur caused by a speed difference between the movement of the image capturing device and the movement of a subject. The threshold is raised correspondingly to an increase in the travelling speed in a predetermined unit, so that the object area can be identified with a lower evaluation value as the speed increases.

The (4) “Braking Amount”, among the operations listed above, represents a braking amount corresponding to the operation performed on the brake pedal, and is associated with the detection algorithm “Blur Removal” and a detection model “Vertical Blur” as the detection parameters. It is also understood that the threshold is set as appropriate based on the braking amount.

More specifically, the blur removal applied to the operation “Braking Amount” is a detection algorithm for detecting the object area after removing blur in the captured image 40. The vertical blur represents a detection model (referred to as a Vertical Blur model) that detects an object area using a classifier trained with captured images 40 with vertical blur. The threshold is lowered when the braking amount exceeds the level causing wheels to lock by a predetermined degree or more, so that the object area can be identified with a lower evaluation value when the braking amount increases.

The (5) “Steering Wheel Angle”, among the operations listed above, represents a change in the travelling direction of the ego-vehicle that is based on a steering wheel angle, and is associated with the detection algorithm “Blur Removal” and the detection model “Motion Blur” as the detection parameters. It is also understood that the threshold is set as appropriate based on the steering wheel angle.

More specifically, the blur removal applied to the operation “Steering Wheel Angle” is a detection algorithm for detecting the object area after removing the blur in the captured image 40. The Motion Blur model described above is used as the detection model. Based on the steering wheel angle, the threshold is lowered as the angle is increased in a direction causing the ego-vehicle to turn.

The (6) “Blinkers”, among the operations listed above, represents an operation of turning on or off of the blinkers, and which one of the right or left blinkers are on, if the blinkers are turned on, and is associated with the detection algorithm “Blur Removal” and a detection model “Motion Blur” as the detection parameters. It is also understood that the threshold is set as appropriate based on on or off of the blinkers.

More specifically, the blur removal applied to the operation “Blinkers” is a detection algorithm for detecting the object area after removing the blur in the captured image 40. The Motion Blur model is used as the detection model. The threshold is lowered on the side on which either the left or the right blinkers are turned on.

The (7) “Air Conditioner”, among the operations listed above, represents an operation of turning on or off the air conditioner, and an operation of setting a temperature to the air conditioner (cooler/heater). Used as a detection parameter is a detection algorithm not performing any pre-processing before detecting the object area. A “Clothing Type model” is associated as the detection model. It is also understood the threshold is set as appropriate based on the amount of airflow set to the air conditioner.

More specifically, in the “Air Conditioner” operation, used as a detection model is a model for detecting the object area using a classifier trained with images of persons in types of clothing corresponding to the temperature settings of the air conditioner. In other words, the “Clothing Type model” includes a plurality of detection models corresponding to patterns of clothing, and the classifier is provided in plurality, one for each of the detection models. The threshold is lowered as the amount of airflow is increased, based on the airflow setting of the air conditioner, so that the object area can be identified with a lower evaluation value.

In FIG. 7, priority is associated to each of the operations. The priority indicates the order in which the operation information is selected when the detection parameter setting unit 202 determines that the information of a plurality of operations has been changed. The priority should be assigned in the descending order of the scale of a change in the captured image 40 caused when the operation information is changed, for example. In the example illustrated in FIG. 7, the operation “Lights On, Light Direction” has the highest priority, and the operation “Wiper”, the operation “Travelling Speed”, the operation “Braking Amount”, the operation “Steering Wheel Angle”, the operation “Blinkers”, and the operation “Air Conditioner” follow, in the descending order of the priority.

Exemplary Detection Process with “Lights on, Light Direction” Operation

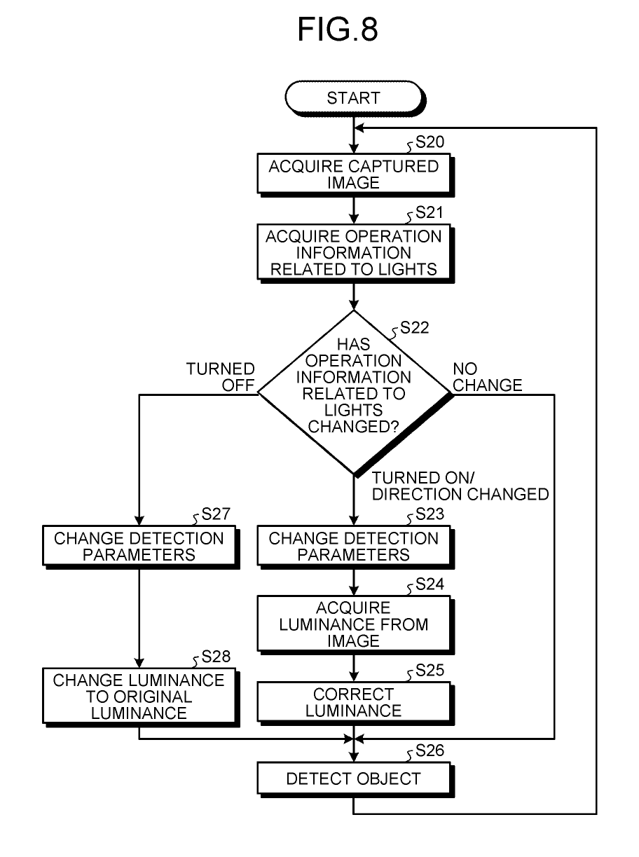

The object area detection process according to the first embodiment will now be specifically explained, for each of the operations illustrated in FIG. 7. The detection process performed by the detecting device 20 when the operation is (1) “Lights On, Light Direction” operation will now be explained. FIG. 8 is a flowchart illustrating an exemplary object area detection process performed by the detecting device 20 according to the first embodiment when the operation is “Lights On, Light Direction”.

Before executing the process illustrated in the flowchart in FIG. 8, the object area to be detected from the captured image 40 is determined to be, for example, an image of a person. The classifier used at Step S101 in the flowchart in FIG. 6 is also trained with images of a person being an object of the detection, and images of other objects to be excluded from detection. The classifier is trained with images of a person in a dark place, based on the detection model specified as a detection parameter. The classifier is also trained with images of a person under normal luminance.

At Step S20 in the flowchart illustrated in FIG. 8, the detecting device 20 causes the image acquiring unit 200 to acquire a captured image from the camera 36R, and sends the acquired captured image to the detector 203.

At the following Step S21, the operation information acquiring unit 201 acquires the operation information indicating the operation related to the lights performed in the ego-vehicle. At the following Step S22, the detection parameter setting unit 202 compares, for the operation related to the lights, the operation information having been previously acquired and the operation information having just been acquired, and determines if the operation information has changed. If the detection parameter setting unit 202 determines that the operation information has changed, the detection parameter setting unit 202 determines the type of the change.

If the detection parameter setting unit 202 determines that the operation information related to the lights has not changed at Step S22, the detection parameter setting unit 202 shifts the processing to Step S26. At Step S26, the detector 203 performs the object area detection process following the flowchart illustrated in FIG. 6, using the detection model and the threshold currently set as the detection parameters. Once the detection process performed by the detector 203 is completed, the process of the detecting device 20 returns to Step S20.

If the detection parameter setting unit 202 determines that the operation information related to the lights has changed at Step S22, and the change is one of a change from off to on or a change in the direction of the lights, the detection parameter setting unit 202 shifts the processing to Step S23.

At Step S23, the detection parameter setting unit 202 changes the detection parameters based on the result of the determination at Step S22, and sets the changed detection parameters to the detector 203. The detection parameter setting unit 202 changes the detection algorithm to “Luminance Adjustment”, and changes the detection model to the Dark Place model, by which the classifier trained with images of dark places, with reference to the table illustrated in FIG. 7.

The detection parameter setting unit 202 also changes the threshold based on the positions illuminated by the lights. More specifically, if the direction of the lights is set to bright, the detection parameter setting unit 202 sets a lower threshold in the peripheral area of the captured image, than the threshold set to the area near the center of the captured image illuminated by the light. If the direction of the lights is set to dim, the detection parameter setting unit 202 sets a lower threshold to the area above the center of the captured image, than the threshold set to the area below the center of the captured image illuminated by the light.

At the following Step S24, the detector 203 acquires the luminance of the captured image. The detector 203 may acquires the luminance from the entire captured image, or may acquire the luminance of a predetermined area of the captured image, e.g., the area corresponding to a road surface presumably illuminated by the light.

At the following Step S25, the detector 203 corrects the luminance of the captured image acquired at Step S24 to the level achieving the highest object area detection performance. The detector 203 may correct the luminance of the captured image through, for example, gamma correction expressed by Equation (1). In Equation (1), Y₀ is a pixel value in the input image (captured image), and Y₁ is the corresponding pixel value in the output image (the image resulting from the conversion). In Equation (1), the bit depth of the pixel value is set to eight bits (256 gradients).

Y₁=255×(Y₀/255)^{1/γ} (1)

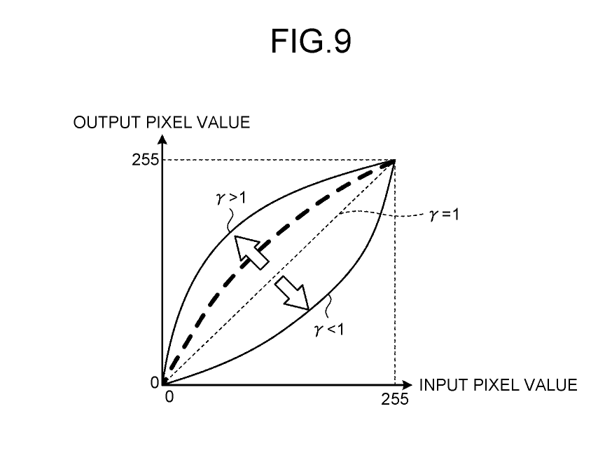

With Equation (1), the input pixel values are equal to the output pixel values when γ=1, as illustrated in FIG. 9. When γ is larger than 1, the output pixel values in the halftone range are higher than the input pixel values, resulting in an image with lighter halftone. When γ is less than 1, the output pixel values in the halftone range are lower than the input pixel values, resulting in an image with darker halftone. The detector 203 may, for example, change γ so that the average of the pixel values of the area estimated to be a road surface in the captured image has predetermined luminance.

The way in which the luminance of the captured image is adjusted is not limited to the gamma correction. To adjust the luminance of the captured image, the detector 203 may perform, for example, equalization, too. In the equalization, the gradations are divided into a plurality of luminance levels, and the pixels in the captured image are taken out from those with a higher pixel value. Each of the pixels, taken out from those with a higher pixel value, is sequentially assigned to one of the luminance levels of which luminance level is higher, so that the number of pixels classified in each of the luminance levels becomes equal to the number of all of the luminance levels divided by the total number of pixels. The number of pixels assigned to each of the luminance levels is thereby equalized. Without limitation to the equalization, the detector 203 may also perform the luminance adjustment simply by increasing or decreasing the pixel values by a certain level across the entire captured image.

Once the detector 203 completes correcting the luminance of the captured image at Step S25, the detector 203 shifts the processing to Step S26.

If the detection parameter setting unit 202 determines that the operation information related to the lights has changed, and also determines that the change represents the light being turned on to off at Step S22, the detection parameter setting unit 202 shifts the processing to Step S27.

At Step S27, the detection parameter setting unit 202 changes the detection parameters from those for when the light is on to those when the light is off, that is, when the light is not on. Specifically, the detection parameter setting unit 202 changes the detection algorithm to an algorithm without the “luminance correction”. The detection parameter setting unit 202 also changes the detection model and the threshold to those for detecting the object area using a classifier trained with images with normal luminance.

At the following Step S28, the detector 203 changes the luminance of the captured image back to the default luminance, that is, to the luminance resulting from undoing the luminance correction applied to the captured image, and shifts the processing to Step S26.

Exemplary Detection Process with “Wiper” Operation

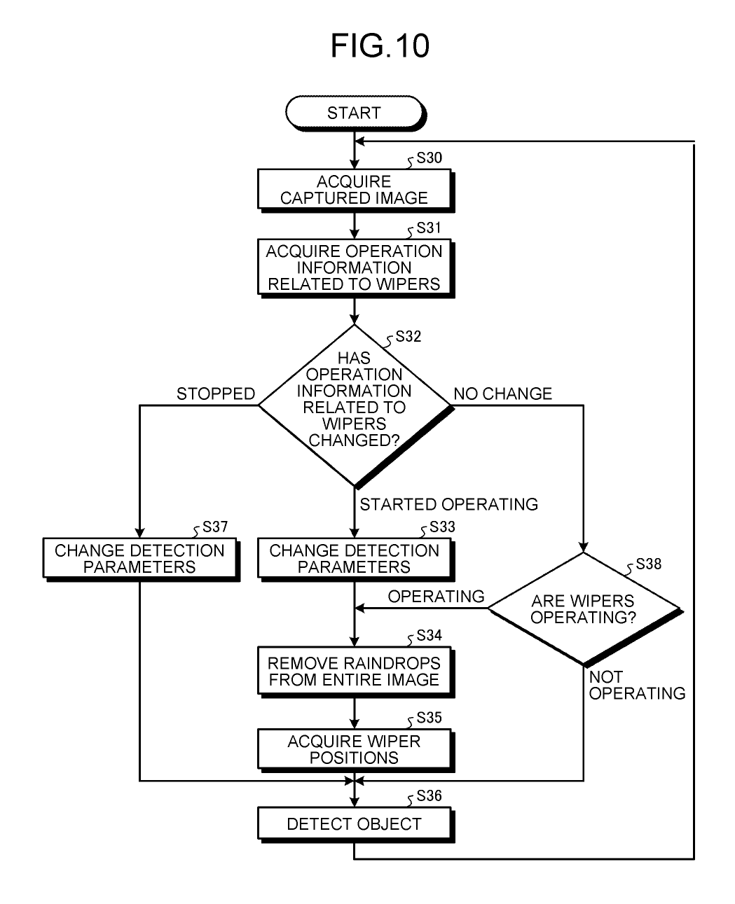

The detection process performed by the detecting device 20 when the operation is (2) “Wiper” operation will now be explained. FIG. 10 is a flowchart illustrating an exemplary object area detection process performed by the detecting device 20 according to the first embodiment when the operation is the “Wiper” operation.

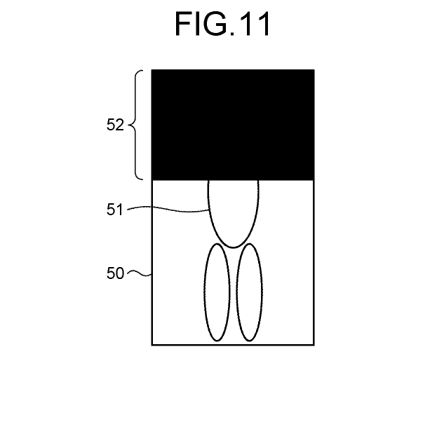

Before executing the process illustrated in the flowchart in FIG. 10, the object area to be detected from the captured image 40 is determined to be, for example, an image of a person. The classifier used at Step S101 in the flowchart in FIG. 6 is also trained with images of a person being an object of the detection, and images of other objects to be excluded from detection. The classifier is trained with images of a person with a part of the detection window 50 masked, based on the detection model specified as a detection parameter. A mask area 52 is provided, for example, to a part of the detection window 50 (in this example, an upper part of the detection window 50), as illustrated in FIG. 11. When an area 51 of a person being the object, for example, is included in the detection window 50, the upper part of the area 51 corresponding to the person is masked by the mask area 52.

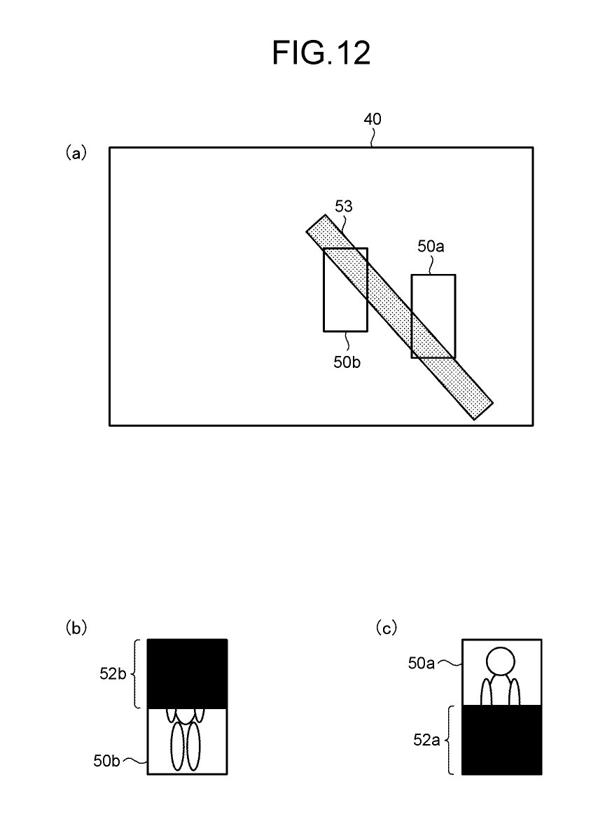

The classifier is trained with different detection windows 50 each provided with a mask area 52 positioned correspondingly to each wiper arm position. FIG. 12 illustrates setting of the mask area based on the wiper arm position according to the first embodiment. As illustrated in FIG. 3, the wiper arms 34 are reciprocated by a given angle range about the lower ends of the wiper arms, for example, across the windshield 31 at a given angular speed.

At certain timing of the wiper operation, the image of the wiper arms 34 is captured as a wiper arm area 53 in the captured image 40, as illustrated in (a) in FIG. 12. Because the wiper arm 34 is positioned in front of the subject represented as the area 51 of a person being the object with respect to the camera 36R, when the detection window 50 comes to a position at which the wiper arm area 53 overlaps with the person area 51, a part of the person area 51 may be hidden by the wiper arm area 53, whereby preventing the detector 203 from correctly detecting the object area.

To address this issue, in the first embodiment, a plurality of classifiers each of which is trained with detection windows 50 each provided with a mask area 52 at a different position are used. The detector 203 then switches the classifiers based on the position of the wiper arm area 53, that is, the position of the wiper arm 34, and the current position of the detection window 50 in the captured image 40 before detecting the object area.

A first classifier is trained with a detection window 50b of which upper part is provided with a mask area 52b, and a second classifier is trained with a detection window 50a of which lower part is provided with a mask area 52a in advance, as illustrated in (a) and (b) in FIG. 12, respectively. Before detecting the object area, the detector 203 switches the first and the second classifiers based on the positional relation between the wiper arm area 53 and the detection window 50.

More specifically, as illustrated in (a) in FIG. 12, the detector 203 uses the first classifier trained with the detection window 50b when the wiper arm area 53 overlaps with an upper part of the detection window 50. The detector 203 uses the second classifier trained with the detection window 50a when the wiper arm area 53 overlaps with a lower part of the detection window 50.

At Step S30 in the flowchart illustrated in FIG. 10, the detecting device 20 causes the image acquiring unit 200 to acquire a captured image from the camera 36R, and sends the acquired captured image to the detector 203. At the following Step S31, the operation information acquiring unit 201 acquires the operation information indicating the operation related to the wipers of the ego-vehicle.

At the following Step S32, the detection parameter setting unit 202 compares, for the operation related to the wipers, the operation information having been previously acquired and the operation information having just been acquired, and determines if the operation information has changed. If the detection parameter setting unit 202 determines that the operation information has changed, the detection parameter setting unit 202 determines the type of the change. If the detection parameter setting unit 202 determines that the operation information related to the wipers has changed, and also determines that the change is from non-operating to operating of the wipers at Step S32, the detection parameter setting unit 202 shifts the processing to Step S33.

At Step S33, the detection parameter setting unit 202 changes the detection parameters based on the result of the determination at Step S32, and sets the changed detection parameters to the detector 203. In this example, the detection parameter setting unit 202 changes the detection algorithm to the “Defocus Removal” with reference to the table illustrated in FIG. 7, and changes the detection model to the Masked model, that is, a model using a classifier trained with the detection window 50 provided with the mask area 52.

The detection parameter setting unit 202 also changes the threshold based on the wiper position. More specifically, the detection parameter setting unit 202 calculates the position of the wiper arm area 53 in the captured image 40 based on the positions of the wiper arms 34 acquired by the operation information acquiring unit 201 at Step S31. The detection parameter setting unit 202 then sets a lower threshold to a predetermined area from and including the wiper arm area 53, than that used in the area outside of this area.

At the following Step S34, the detector 203 removes defocus from the captured image 40. In this example, the detector 203 performs a process of removing the images of rain drops from the captured image 40, as the defocus removal.

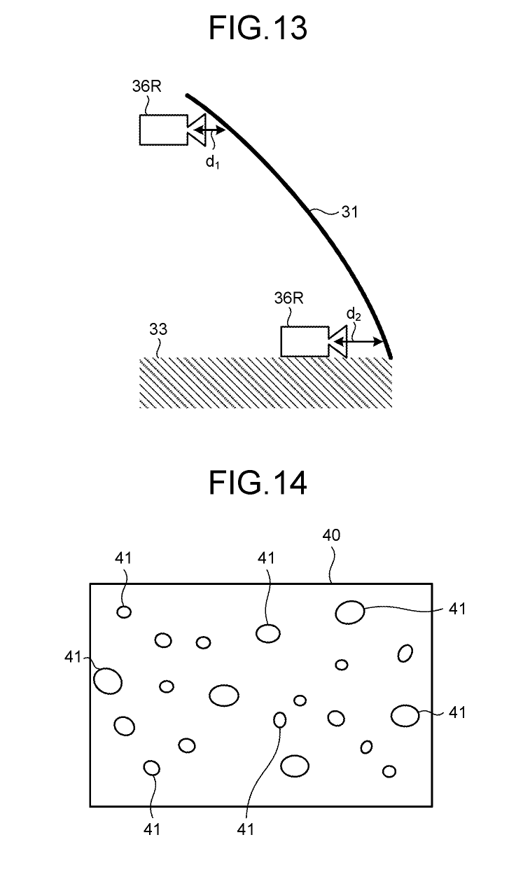

When the camera 36R is positioned inside of the vehicle, for example, there is a fixed distant d between the front lens of the camera 36R and the windshield 31. FIG. 13 illustrates an example of a distance d₁ or d₂ between the front lens of the camera 36R and the windshield 31, when the camera 36R is positioned on the ceiling or on the dashboard 33.

When there is a fixed distance d between the front lens of the camera 36R and the windshield 31, and rain falls on the windshield 31, rain drop images 41, 41, . . . are captured in the image 40 captured by the camera 36R, as illustrated in FIG. 14. When the rain drop images 41, 41, . . . overlap with the object area, the resultant object area becomes different from the object image originally intended, so the object area may not be detected correctly.

To address this issue, in the first embodiment, rain drops are removed from the captured image 40 as the defocus removal at Step S34, so that the rain drop images 41, 41, . . . are removed from the captured image 40. An example of the rain drops removal is disclosed in INABA Hiroshi, OSHIRO Masakuni, KAMATA Sei-ichiro, “Raindrop removal from in-vehicle camera images based on matching adjacent frames”, Institute of Electronics, Information, and Communication Engineers (2011).

According to the disclosure, the detector 203 detects the areas corresponding to the rain drop images 41, 41, . . . (rain drop areas) in a frame of the captured image 40 from which the rain drop images 41, 41, . . . are to be removed (referred to as a target frame) and several frames prior to the target frame (previous frames). The rain drop areas may be detected by, for example, applying edge detection to the captured image 40. The detector 203 then interpolates the areas corresponding to the rain drops in the target frame using luminance information of the rain drop areas in the target frame and the luminance information of the rain drop areas corresponding to the rain drop areas in the target frame in the previous frames. This technology uses the fact that, assuming that the vehicle travels linearly, the array of pixels on a line connecting one point in the image of the target frame to the vanishing point in front of the camera 36R can be found in the previous frame as an extension or contraction of the same pixel array.

At the following Step S35, the operation information acquiring unit 201 acquires the information indicating the positions of the wiper arms 34. The information indicating the positions of the wiper arms 34 can be acquired from, for example, the wiper control device 15. The detector 203 then determines the position of the wiper arm area 53 in the captured image 40 based on the positions of the wiper arms 34 acquired by the operation information acquiring unit 201. Once the position of the wiper arm area 53 is determined, the detector 203 shifts the processing to Step S36.

The detector 203 switches to the first classifier or to the second classifier with which the object area is detected, based on the position of the wiper arm area 53 determined at Step S35.

At Step S32, the detection parameter setting unit 202 compares, for the operation related to the wipers, the operation information having been previously acquired and the operation information having just been acquired, and determines if the operation information has changed. If the detection parameter setting unit 202 determines that the operation information has changed, the detection parameter setting unit 202 determines the type of the change.

If the detection parameter setting unit 202 determines that the operation information related to the wipers has changed, and the type of the change is a change from operating to non-operating of the wipers at Step S32, the detection parameter setting unit 202 shifts the processing to Step S37.

At Step S37, the detection parameter setting unit 202 changes the detection parameters from those for when the wipers are operating to those for when the wipers are not operating, and sets the detection parameters to the detector 203. Specifically, the detection parameter setting unit 202 changes the detection algorithm to that not performing the “Defocus Removal”, and changes the detection model and the threshold to those for detecting the object image with a classifier trained with a detection window 50 without any mask area 52. The detection parameter setting unit 202 then shifts the processing to Step S36.

If the detection parameter setting unit 202 determines that there has been no change in the operation information related to the wipers at Step S32, the detection parameter setting unit 202 shifts the processing to Step S38. At Step S38, the detection parameter setting unit 202 determines if the wipers are currently operating or not operating. If the detection parameter setting unit 202 determines that the wipers are currently operating, the detection parameter setting unit 202 shifts the processing to Step S34. If not, the detection parameter setting unit 202 shifts the process to Step S36.

At Step S36, the detector 203 performs the object area detection process following the flowchart illustrated in FIG. 6, using the detection model and the threshold currently set as the detection parameters. Once the detection process performed by the detector 203 is completed, the process of the detecting device 20 returns to Step S30.

Exemplary Detection Process with “Travelling Speed” Operation

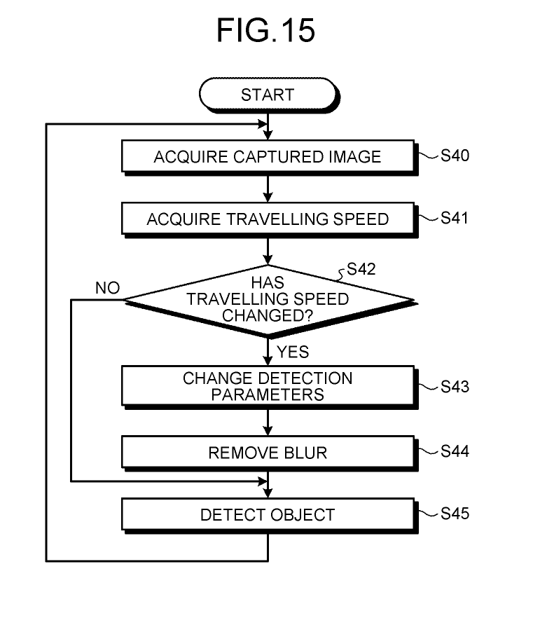

The detection process performed by the detecting device 20 when the operation is (3) “Travelling Speed” operation will now be explained. FIG. 15 is a flowchart illustrating an exemplary object area detection process performed by the detecting device 20 according to the first embodiment when the operation is the “Travelling Speed”. Before executing the process illustrated in the flowchart in FIG. 15, the object area to be detected from the captured image is determined to be, for example, an image of a person. The classifier used at Step S101 in the flowchart illustrated in FIG. 6 is also trained in advance, with a model using images including motion blurs in the area corresponding to a person being the object.

In the detecting device 20, the image acquiring unit 200 acquires a captured image from the camera 36R at Step S40, and sends the acquired captured image to the detector 203.

At the following Step S41, the operation information acquiring unit 201 acquires the travelling speed of the ego-vehicle. At the following Step S42, the detection parameter setting unit 202 compares the travelling speed previously acquired and the travelling speed having just been acquired, and determines if the travelling speed has changed. It is preferable for the detection parameter setting unit 202 to add a given margin to a difference in the travelling speed for determining if the travelling speed has been changed. If the difference in the travelling speed is smaller than the given margin, the detection parameter setting unit 202 shifts the processing to Step S45.

If the detection parameter setting unit 202 determines that the travelling speed has changed at Step S42, the detection parameter setting unit 202 shifts the processing to Step S43. At Step S43, the detection parameter setting unit 202 changes the detection parameters with which the object area is detected from the captured image by the detector 203, based on the travelling speed having just been acquired. More specifically, the detection parameter setting unit 202 changes the detection algorithm to the “Blur Removal”, and changes the detection model to the Motion Blur model. The detection parameter setting unit 202 also changes the threshold based on the travelling speed. More specifically, the detection parameter setting unit 202 sets a lower threshold when the travelling speed is higher. The detection parameter setting unit 202, for example, lowers the threshold by a given degree when the travelling speed is increased by a given degree.

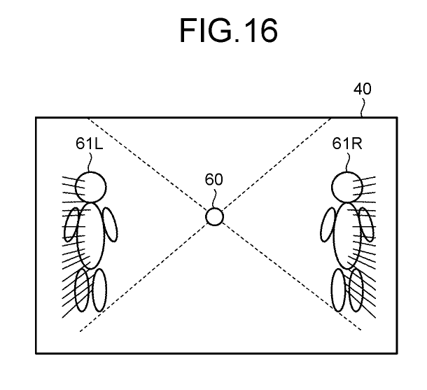

At the following Step S44, the detector 203 removes blur from the captured image received from the image acquiring unit 200 at Step S40. When the ego-vehicle is in motion, radial motion blur, extending from the vanishing point 60 to the peripheries of the captured image 40, appears in the captured image 40, as illustrated in FIG. 16. An image 61R on the right side of the vanishing point 60, for example, is blurred outside with respect to the vanishing point 60, that is, blur appears on the right side of the image 61R. Similarly, an image 61L on the left side of the vanishing point 60 is blurred on the left side of the image 61L. To address this issue, in the first embodiment, the detector 203 performs blur removal for removing the radial blur from the captured image 40 as a pre-process, following the detection algorithm.

To remove blurs from the images, the technology disclosed in C. Inoshita, Y. Mukaigawa, and Y. Yagi, “Ringing Detector for Deblurring based on Frequency Analysis of PSF”, IPSJ Transactions on Computer Vision and Applications (2011) can be used, for example.

The ringing detector according to this disclosure first performs a division of a blurred image by a point spread function, and finds the frequency features of the original image. By taking an inverse Fourier transform of the frequency features, the ringing detector restores the original image from the blurred image. From the restored original image, the ringing detector searches for a component with an extremely small power value in the frequency domain of the point spread function. The ringing detector then determines if the ringing is present by receiving the inputs of the restored image and a noninvertible frequency that is based on this component of the point spread function, and by checking if a sine wave corresponding to the frequency component with uniform phase is found across the entire restored image. If the component is determined to be the error component based on the output from the ringing detector, the ringing detector estimates the phase and the amplitude that are unknown parameters of the error component, and removes the error component from the restored image. If the component is not determined to be the error component, the ringing detector searches for a component with an extremely small power value in the frequency domain of the point spread function, and repeats the process thereafter.

Once the blur removal at Step S44 is completed, the detector 203 shifts the processing to Step S45, and performs the object area detection process to the captured image 40 with blurs removed, following the flowchart illustrated in FIG. 6, using the detection model and the threshold set as the detection parameters. Once the detection process performed by the detector 203 is completed, the process of the detecting device 20 returns to Step S40.

Exemplary Detection Process with “Braking Amount” Operation

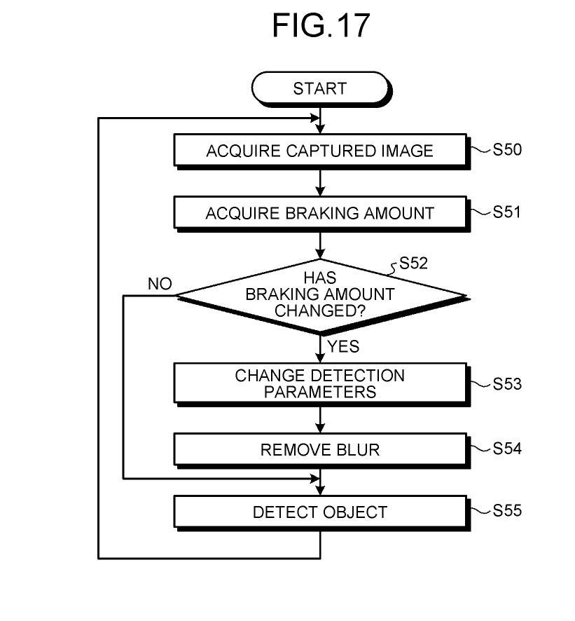

The detection process performed by the detecting device 20 when the operation is (4) “Braking Amount” operation will now be explained. FIG. 17 is a flowchart illustrating an exemplary object area detection process performed by the detecting device 20 according to the first embodiment when the operation is the “Braking Amount”. Before executing the process illustrated in the flowchart in FIG. 17, the object area to be detected from the captured image 40 is determined to be, for example, an image of a person. The classifier used at Step S101 in the flowchart illustrated in FIG. 6 is also trained in advance, with a model using images with vertical blur in the area corresponding to a person being the object.

In the detecting device 20, the image acquiring unit 200 acquires the captured image 40 from the camera 36R at Step S50, and sends the acquired captured image 40 to the detector 203.

At the following Step S51, the operation information acquiring unit 201 acquires the braking amount of the ego-vehicle. At the following Step S52, the detection parameter setting unit 202 compares the braking amount having been previously acquired and the braking amount having just been acquired, and determines if the braking amount has changed. It is preferable for the detection parameter setting unit 202 to add a given margin to the braking amount used in determining whether the braking amount has changed. If the difference in the braking amount is smaller than the given margin, the detection parameter setting unit 202 shifts the processing to Step S55.

If the detection parameter setting unit 202 determines that the braking amount has changed at Step S52, the detection parameter setting unit 202 shifts the processing to Step S53. At Step S53, the detection parameter setting unit 202 changes the detection parameters with which the object area is detected from the captured image 40 by the detector 203, based on the braking amount having just been acquired. More specifically, the detection parameter setting unit 202 changes the detection algorithm to the “Blur Removal”, and changes the detection model to the Vertical Blur model. The detection parameter setting unit 202 also changes the threshold based on the braking amount. More specifically, the detection parameter setting unit 202 sets a lower threshold when a braking amount is large. The detection parameter setting unit 202 sets a lower threshold when, for example, the braking amount takes up a given ratio or more of the braking amount causing the wheels to lock.

At the following Step S54, the detector 203 removes vertical blur from the captured image 40 received from the image acquiring unit 200 at Step S50, following the detection algorithm. When the ego-vehicle is caused to stop with, for example, a braking amount equal to a given ratio or more of the braking amount causing the wheels to lock, inertia causes the front side of the body to swing up and down, so vertical blur may appear in the captured image 40. The detector 203 removes this vertical blur, in the up and down direction, as a pre-process, before performing object detection process. The technology disclosed by C. Inoshita et al. may be used in removing vertical blur from the captured image 40.

Once the blur removal at Step S54 is completed, the detector 203 shifts the processing to Step S55, and performs the object area detection process to the captured image 40 with blur removed, following the flowchart illustrated in FIG. 6, using the detection model and the threshold set as the detection parameters. Once the detection process performed by the detector 203 is completed, the process of the detecting device 20 returns to Step S50.

Exemplary Detection Process with “Steering Wheel Angle” Operation

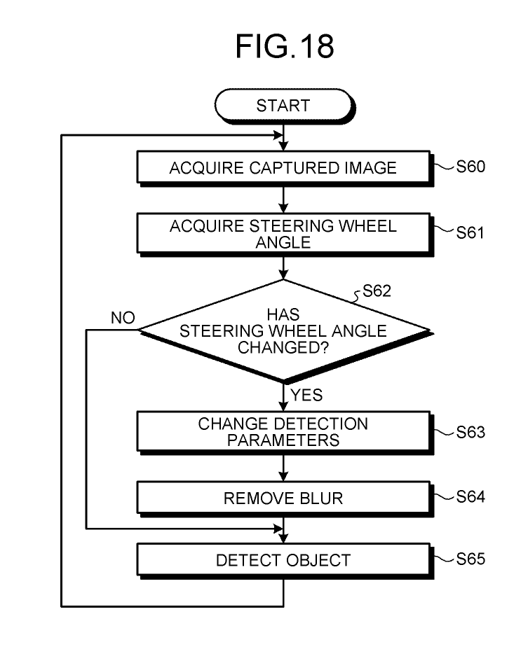

The detection process performed by the detecting device 20 when the operation is (5) “Steering Wheel Angle” operation will now be explained. FIG. 18 is a flowchart illustrating an exemplary object image detection process performed by the detecting device 20 according to the first embodiment when the operation is the “Steering Wheel Angle”.

Before executing the process illustrated in the flowchart in FIG. 18, the object area to be detected from the captured image 40 is determined to be, for example, an image of a person. The classifier used at Step S101 in the flowchart illustrated in FIG. 6 is trained in advance, with a model using images with motion blur in the area corresponding to a person being the object.

In the detecting device 20, the image acquiring unit 200 acquires the captured image 40 from the camera 36R at Step S60, and sends the acquired captured image 40 to the detector 203.

At the following Step S61, the operation information acquiring unit 201 acquires the steering wheel angle of the ego-vehicle. At the following Step S62, the detection parameter setting unit 202 compares the steering wheel angle having been previously acquired and the steering wheel angle having just been acquired, and determines if the steering wheel angle has changed and in which direction the steering wheel angle has changed, if there has been any change. It is preferable for the detection parameter setting unit 202 to add a given margin to the angle for determining that the steering wheel angle has changed. If the difference in the steering wheel angle is smaller than the given margin, the detection parameter setting unit 202 shifts the processing to Step S65.

If the detection parameter setting unit 202 determines that steering wheel angle has changed at Step S62, the detection parameter setting unit 202 shifts the process to Step S63. At Step S63, the detection parameter setting unit 202 changes the detection parameters with which the object area is detected from the captured image 40 by the detector 203 based on the steering wheel angle having just been acquired.

More specifically, the detection parameter setting unit 202 changes the detection algorithm to the “Blur Removal”, and changes the detection model to the travelling-direction Motion Blur model. The detection parameter setting unit 202 also changes the threshold every time the steering wheel angle reaches a predetermined angle. The detection parameter setting unit 202 lowers the threshold, for example, as the steering wheel angle increases more with respect to the travelling direction. This is intended to allow objects to be detected more easily in a direction in which the ego-vehicle turns, because accidents are more likely to occur in a direction in which a vehicles turns.

At the following Step S64, the detector 203 removes blur from the captured image 40 received from the image acquiring unit 200 at Step S60, following the detection algorithm. The technology disclosed by C. Inoshita et al. may be used in removing blur from the captured image 40.

Once the blur is removed at Step S64, the detector 203 shifts the processing to Step S65, and performs the object area detection process to the captured image 40 with blur removed, following the flowchart illustrated in FIG. 6, using the detection model and the threshold set as the detection parameters. At this time, the detector 203 determines the travelling direction of the ego-vehicle based on the steering wheel angle, and selects a classifier trained with images with motion blur. Once the detection process performed by the detector 203 is completed, the process of the detecting device 20 returns to Step S60.

Exemplary Detection Process with “Blinkers” Operation

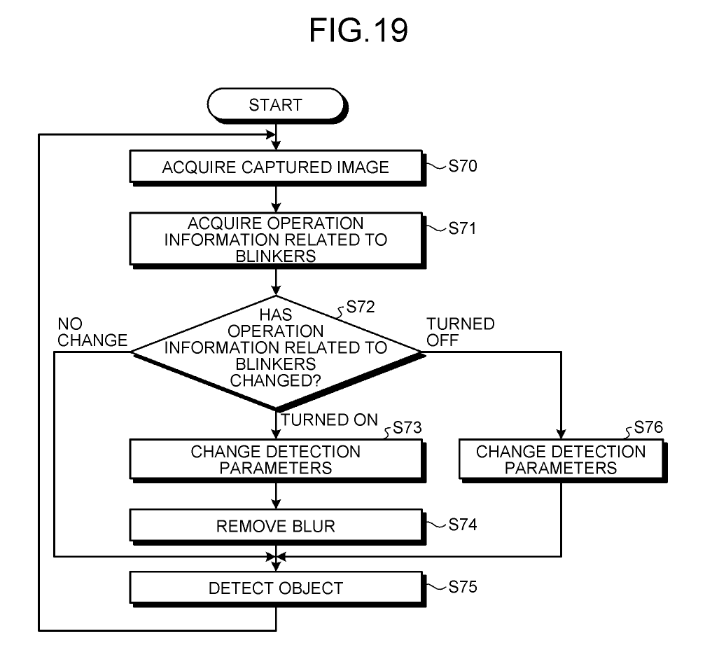

The detection process performed by the detecting device 20 when the operation is (6) “Blinkers” operation will now be explained. FIG. 19 is a flowchart illustrating an exemplary object area detection process performed by the detecting device 20 according to the first embodiment when the operation is “Blinkers”.

Before executing the process illustrated in the flowchart in FIG. 19, the object area to be detected from the captured image 40 is determined to be, for example, an image of a person. The classifier used at Step S101 in the flowchart illustrated in FIG. 6 is also trained in advance with a model using images including a person being an object with motion blur.

In the detecting device 20, the image acquiring unit 200 acquires the captured image 40 from the camera 36R at Step S70, and sends the acquired captured image 40 to the detector 203.

At the following Step S71, the operation information acquiring unit 201 acquires the operation information indicating the operation related to the blinkers. The operation information includes information of which of the left and the right blinkers are on. When the left and the right blinkers are both on, the operation information acquiring unit 201 may disregard the information, or consider none of the blinkers on.

At the following Step S72, the detection parameter setting unit 202 compares, for the operation related to the blinkers, the operation information having been previously acquired and the operation information having just been acquired, and determines if the operation information has changed. If the detection parameter setting unit 202 determines that operation information has not changed, the detection parameter setting unit 202 shifts the processing to Step S75.

If the detection parameter setting unit 202 determines that the operation information has changed at Step S72, the detection parameter setting unit 202 determines the type of the change. If the detection parameter setting unit 202 determines that the change is that the left or the right blinkers being turned on from off at Step S72, the detection parameter setting unit 202 shifts the processing to Step S73.

At Step S73, the detection parameter setting unit 202 changes the detection parameters with which the object area is detected from the captured image by the detector 203, based on whether the blinkers having changed from off to on are either left or right blinkers. More specifically, the detection parameter setting unit 202 changes the detection algorithm to the “Blur Removal”, and changes the detection model to the Motion Blur model.

The detection parameter setting unit 202 changes the threshold used for the side on which the blinkers are turned on to a lower threshold. When the blinkers on the right side are on, for example, the detection parameter setting unit 202 uses a lower threshold on the right side of the captured image 40 than the threshold set to the left side. This is intended to allow objects to be detected more easily in a direction in which the ego-vehicle turns, in the same manner as for the steering wheel angle, because accidents are more likely to occur in a direction in which a vehicle turns.

At the following Step S74, the detector 203 removes blur from the captured image 40 received from the image acquiring unit 200 at Step S70, following the detection algorithm. The technology disclosed by C. Inoshita et al. may be used in removing blur from the captured image 40.

Once the blur is removed at Step S74, the detector 203 shifts the processing to Step S75, and performs the object area detection process to the captured image 40 with blur removed, following the flowchart illustrated in FIG. 6, using the detection model and the threshold changed and set by the detection parameter setting unit 202. Once the detection process performed by the detector 203 is completed, the process of the detecting device 20 returns to Step S70.

If the detection parameter setting unit 202 determines that the operation information has changed at Step S72, and determines that the change represents the left or the right blinkers being turned off from on, the detection parameter setting unit 202 shifts the processing to Step S76.

At Step S76, the detection parameter setting unit 202 changes the detection parameters to those for when the blinkers are not on. Specifically, the detection parameter setting unit 202 changes the detection algorithm to the detection algorithm not performing blur removal. The detection parameter setting unit 202 also changes the detection model to a model that uses a classifier trained with images without motion blur, and sets the same threshold across the entire captured image 40.

Exemplary Detection Process with “Air Conditioner” Operation

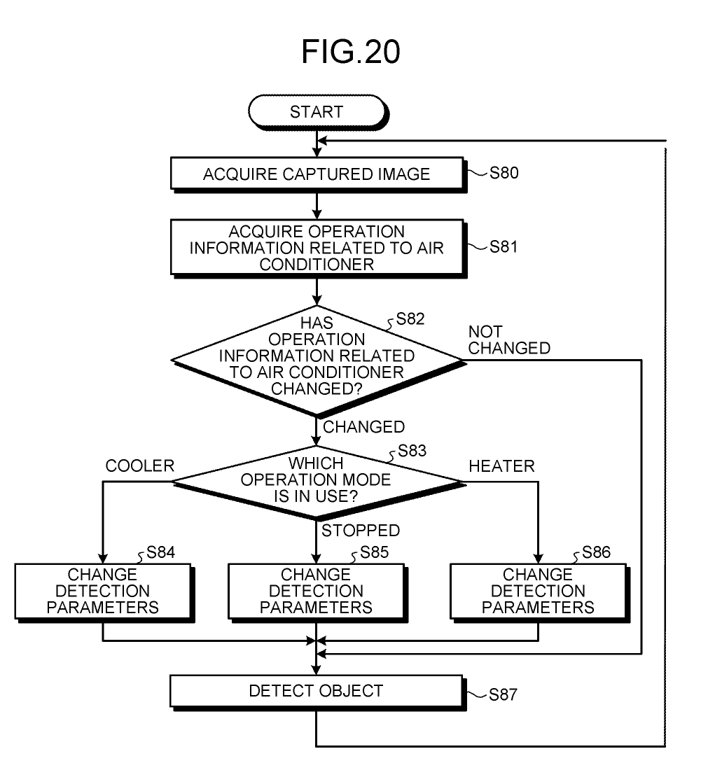

The detection process performed by the detecting device 20 when the operation is (7) “Air Conditioner” operation will now be explained. FIG. 20 is a flowchart illustrating an exemplary object area detection process performed by the detecting device 20 according to the first embodiment when the operation is “Air Conditioner”.

Before executing the process illustrated in the flowchart in FIG. 20, the object area to be detected from the captured image 40 is determined to be, for example, an image of a person. As the classifier used at Step S101 in the flowchart illustrated in FIG. 6, a plurality of classifiers are trained with a plurality of clothing patterns that are assumed based on ambient temperatures. Assumed in this example are three clothing patterns including a first clothing pattern corresponding to the winter time in which the ambient temperature is low, a second clothing pattern corresponding to the summer in which the ambient temperature is high, and a third clothing pattern corresponding to the seasons in which the ambient temperature is between those of the winter and the summer. A first classifier, a second classifier, and a third classifier are then trained with the first clothing pattern, the second clothing pattern, and the third clothing pattern, respectively.

In the detecting device 20, the image acquiring unit 200 acquires the captured image 40 from the camera 36R at Step S80, and sends the acquired captured image 40 to the detector 203.

At the following Step S81, the operation information acquiring unit 201 acquires the operation information indicating an operation related to the air conditioner. This operation information includes information indicating whether the air conditioner is operating, information indicating the operation mode of the air conditioner (e.g., cooler, heater, not operating), and information indicating the amount of airflow from the air conditioner.

At the following Step S82, the detection parameter setting unit 202 compares, for the operation related to the air conditioner, the operation information having been previously acquired and the operation information having just been acquired, and determines if the operation information has changed. If the detection parameter setting unit 202 determines that operation information has not changed, the detection parameter setting unit 202 shifts the processing to Step S87.

If the detection parameter setting unit 202 determines that the operation information has changed at Step S82, the detection parameter setting unit 202 determines the type of the change based on the operation mode of the air conditioner at the following Step S83. If the detection parameter setting unit 202 determines that the operation mode of the air conditioner is cooler at Step S83, the detection parameter setting unit 202 shifts the processing to Step S84. If the operation mode is cooler, it can be expected that the ambient temperature is high, and that people outside of the vehicle are in the clothing in the second clothing pattern. Examples of the second clothing pattern include short-sleeves and light clothing.

At Step S84, the detection parameter setting unit 202 changes the detection parameters to those corresponding to the second clothing pattern. With these detection parameters, the detection model is changed to a model for detecting the second clothing pattern, and a lower threshold is used when the amount of the airflow from the air conditioner is set to high. Once the detection parameters are changed, the detection parameter setting unit 202 shifts the processing to Step S87.

If the detection parameter setting unit 202 determines that the operation mode of the air conditioner is non-operating at Step S83, the detection parameter setting unit 202 shifts the processing to Step S85. If the operation mode is non-operating, it can be expected that the ambient temperature is neither high nor low, and people outside of the vehicle are in the clothing in the third clothing pattern. Examples of the third clothing pattern include long-sleeves and somewhat light clothing.

At Step S85, the detection parameter setting unit 202 changes the detection parameters to those corresponding to the third clothing pattern. With these detection parameters, the detection model is changed to a model for detecting the third clothing pattern. The detection parameter setting unit 202 also uses a threshold fixed to a given level, for example. Once the detection parameters are changed, the detection parameter setting unit 202 shifts the processing to Step S87.

If the detection parameter setting unit 202 determines that the operation mode of the air conditioner is heater at Step S83, the detection parameter setting unit 202 shifts the processing to Step S86. If the operation mode is heater, it can be expected that the ambient temperature is low, and people outside of the vehicle are in the clothing in the first clothing pattern. Examples of the first clothing pattern include thick coats, down jackets, and scarves.

At Step S86, the detection parameter setting unit 202 changes the detection parameters to those corresponding to the first clothing pattern. With these detection parameters, the detection model is changed to that for detecting the first clothing pattern, and a lower threshold is used when the amount of airflow from the air conditioner is high. Once the detection parameters are changed, the detection parameter setting unit 202 shifts the processing to Step S87.

At Step S87, the detector 203 performs the object area detection process, following the flowchart illustrated in FIG. 6, using the detection model and the threshold changed and set at any one of Steps S84 to S86. Before performing the detection process, the detector 203 selects one of the first to the third classifiers corresponding to the detection model. Once the detection process performed by the detector 203 is completed, the process of the detecting device 20 returns to Step S80.

Combination of Plurality of Operations

Explained now is an example in which changes in the operation information are detected for a plurality of operations among the operations (1) to (7). It is assumed herein, as an example, that the detecting device 20 is performing the processes illustrated in the flowcharts in FIGS. 8, 10, 15, 17, 18, 19 and 20, respectively corresponding to the operations (1) to (7), in parallel. If the operation of which operation information has changed is one of the operations (1) to (7), the detection parameter setting unit 202 sets the detection parameters related to the operation having changed to the detector 203.

If there are a plurality of operations among (1) to (7) of which operation information has changed, and if all of the detection parameters, that is, the detection algorithms, the detection models, and the thresholds related to all of such operations can be changed at the same time, the detection parameter setting unit 202 sets all of the detection parameters to the detector 203. If some of the detection parameters are not allowed to be changed at the same time, the detection parameter setting unit 202 selects the parameter associated with the operation with the highest priority, among those associated to the operations in the detection parameter table, as the parameter to be changed with.

Consider an example in which the detection parameter setting unit 202 determines that there is only one operation, (1) “Lights On, Light Direction”, of which operation information has changed among the operations (1) to (7), and the change is switching of the light from off to on. In this example, the detector 203 can perform the detection process based on the change of the lights being switched from off to on, and based on the direction illuminated by the lights.

In other words, the detection parameter setting unit 202 selects all of the corresponding detection parameters (the detection algorithm, the detection model, and the threshold) at Step S23 in the flowchart illustrated in FIG. 8, and sets the detection parameters to the detector 203. The detector 203 then corrects the luminance of the captured image 40 following the detection algorithm included in the set detection parameters (Steps S24 and S25 in the flowchart illustrated in FIG. 8), selects the detection model using a classifier for dark places, and uses a lower threshold in the area not illuminated by the lights in the captured image 40 based on the direction illuminated by the lights.

Now consider another example in which the detection parameter setting unit 202 determines that there are two operations, (1) “Lights On, Light Direction” and (2) “Wiper”, of which operation information has changed, among the operations (1) to (7) described above, and the changes are switching of the light from off to on, and switching of the wiper from non-operating to operating.

In this example, the Dark Place model is specified for the (1) “Lights On, Light Direction”, and the Masked model is specified for the (2) “Wiper” as the detection models. If these detection models cannot be selected at the same time, the detection parameter setting unit 202 selects the Dark Place model that is the model with a higher priority. Luminance Adjustment is specified for (1) “Lights On, Light Direction”, and Defocus Removal is specified for (2) “Wiper” as the detection algorithms. If these detection algorithms can be selected at the same time, the detector 203, for example, corrects the luminance of the captured image 40, and then performs defocus removal before detecting the object area.

The order in which the selected detection algorithms are executed may be set in advance to the detector 203, for example.

In the manner described above, according to the first embodiment, because the operation information of the ego-vehicle is acquired, object areas can be detected more accurately, without relying on the outer environment conditions.

### Second Embodiment

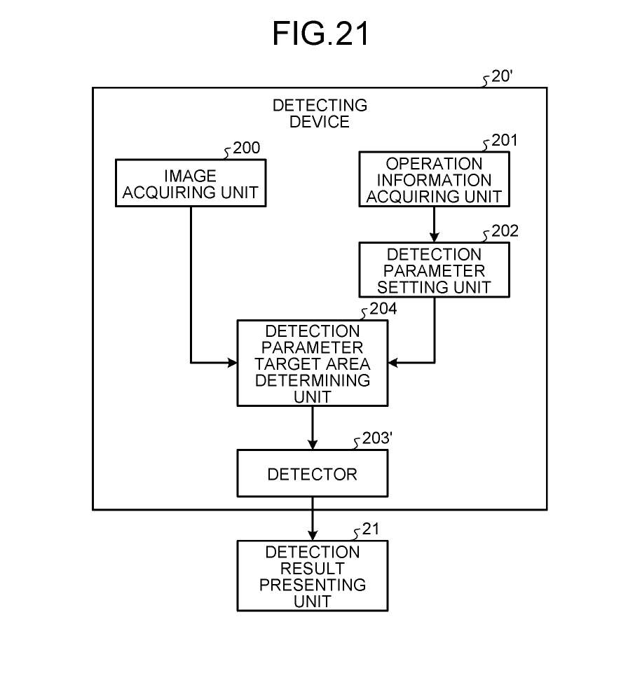

A detecting device according to a second embodiment will now be explained. FIG. 21 illustrates an exemplary configuration of the detecting device according to the second embodiment. In FIG. 21, the parts that are the same with those illustrated in FIG. 1 are assigned with the same reference numerals, and detailed explanations thereof are omitted herein.

As illustrated in FIG. 21, this detecting device 20′ includes a detection parameter target area determining unit 204, in addition to the units in the detecting device 20 explained with reference to FIG. 2. In this configuration, a captured image 40 acquired by the image acquiring unit 200 is sent to the detection parameter target area determining unit 204. Furthermore, the detection parameter setting unit 202 selects information indicating a target area to which the detection parameters corresponding to the operation are applied in addition to the detection parameters themselves from the detection parameter table, if the received operation information having just been acquired has changed from the operation information having been previously acquired by the operation information acquiring unit 201. The detection parameter setting unit 202 sends the selected detection parameters and the information indicating the target area to the detection parameter target area determining unit 204.

The detection parameter target area determining unit 204 forwards the detection parameters received from the detection parameter setting unit 202 and the captured image 40 received from the image acquiring unit 200 to a detector 203′. The detection parameter target area determining unit 204 determines the target area to which the detection parameters are applied from the captured image 40 received from the image acquiring unit 200, based on the target area received from the detection parameter setting unit 202.

The detection parameter target area determining unit 204 then sends information indicating the determined target area to the detector 203′. The detector 203′ applies the detection parameters having been changed based on the change in the operation information to the target area of the captured image 40 determined by the detection parameter target area determining unit 204 before detecting the object area from the captured image 40. In a non-target area that is the area outside of the target area of the captured image 40, the detector 203′ applies the detection parameters before the change is made based on the change in the operation information, before detecting the objects area from the captured image 40.

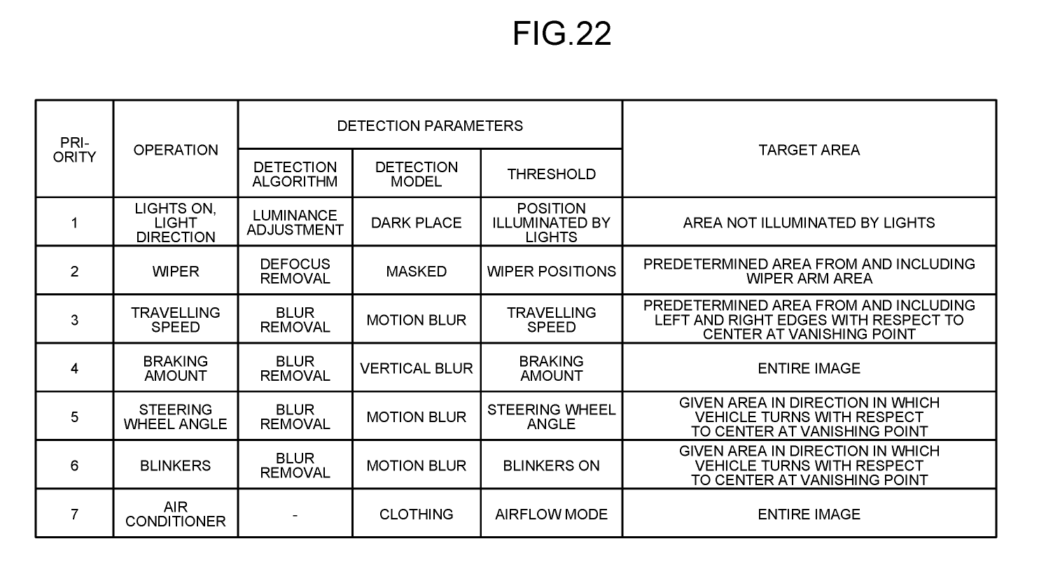

FIG. 22 illustrates an exemplary detection parameter table according to the second embodiment. The detection parameter table illustrated in FIG. 22 is provided with “target area”, in addition to the items in the detection parameter table explained with reference to FIG. 7. Because the other items in the detection parameter table (priority, operation, detection algorithm, detection model, and threshold) are the same as those in the FIG. 7, the explanation hereunder mainly focuses on this item “target area”.

In the detection parameter table illustrated in FIG. 22, for the operation (1) “Lights On, Light Direction”, the area not illuminated by the light is set to the target area in the captured image 40. When the lights are set to bright, for example, predetermined areas along the top and the bottom edges of the captured image 40 are used as target areas. When the lights are set to dim, a predetermined area in the upper part of the image 40 is set as a target area.

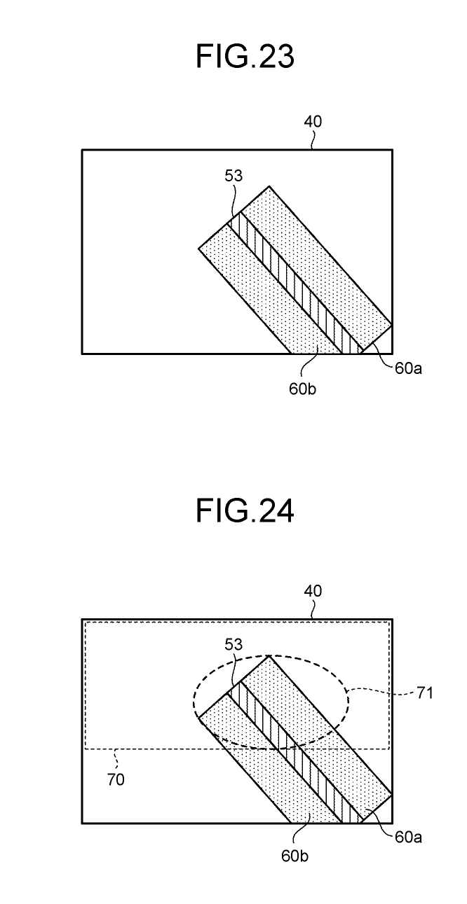

For the operation (2) “Wiper”, a predetermined area with respect to the wiper arm area 53 in the captured image 40 is set as a target area. When the captured image 40 includes a wiper arm area 53, as illustrated in FIG. 23, for example, an area including the wiper arm area 53 and areas 60a and 60b within a given pixel range from the wiper arm area 53 are set as a target area.

For the operation (3) “Travelling Speed”, predetermined areas from and including the left edge and the right edge with respect to the center at the vanishing point 60 is set as a target area in the captured image 40. In the captured image 40 illustrated in FIG. 16, the areas near the left edge and the right edge with respect to the vanishing point 60 are often sidewalks, and it is more likely for such areas to include a person area that is the object area. The changed detection parameters are therefore applied to the areas at the left edge and the right edge with respect to the vanishing point 60.

For the operation (4) “Braking Amount”, the entire captured image 40 is set as a target area. Because vertical swinging of the captured image 40 resulting from braking affects the entire captured image 40, the entire captured image 40 is set as a target area.

For the operation (5) “Steering Wheel Angle” and the operation (6) “Blinkers”, a predetermined area in the direction in which the ego-vehicle turns, with respect to the center at the vanishing point, is set as a target area in the captured image 40. This is intended to allow objects to be detected more easily in a direction in which the ego-vehicle turns, because accidents are more likely to occur in a direction in which a vehicles turns, as already mentioned earlier.

For the operation (7) “Air Conditioner”, the entire captured image 40 is set as a target area.

A detection process performed when the target area is used for the operation (2) “Wiper” will now be explained as an example. For example, the detection parameter target area determining unit 204 calculates the areas 60a and 60b based on the position of the wiper arm area 53 in the captured image 40, the position of the wiper arm area 53 corresponds to the position of the wiper arm 34 acquired by the operation information acquiring unit 201 at Step S35 in FIG. 10, and determines the target area. If the target area is included in the detection window 50 at Step S36 in FIG. 10, for example, the detector 203′ performs the object area detection process using the detection parameters changed at Step S33.

Explained now is another example of a target area determined when the operation information of a plurality of operations has changed, and at least one of a plurality of detection parameters related to each of the operations can be changed at the same time. It is assumed herein that, as an example, the operation information for the operation (1) “Lights On, Light Direction” and the operation (2) “Wiper” has changed.

In this example, for the operation (1) “Lights On, Light Direction”, the area 70 not illuminated by the lights in the captured image 40 is set as the target area when the light is on, as illustrated in FIG. 24. For the operation “Lights On, Light Direction”, therefore, the detector 203′ applies the detection parameters having changed based on the change in the operation information to the area 70, before the object area is detected.

For the operation (2) “Wiper”, the areas 60a and 60b and the wiper arm area 53 are set as the target area, as explained earlier with reference to FIG. 23. The detector 203′, therefore, applies the detection parameters changed based on the change in the information of the operation “Wiper” to the areas 60a and 60b, and the wiper arm area 53, before the object area is detected.

In the example illustrated in FIG. 24, there is an overlapping area 71 in which the area 70 set as a target area for the operation “Lights On, Light Direction” overlaps with the areas 60a, 60b and the wiper arm area 53 set as a target area for the operation “Wiper”. When some of the detection parameters for the operation “Lights On, Light Direction” and the operation “Wiper” cannot be changed at the same time, only the parameter with a higher priority is changed for the overlapping area 71, and the detector 203′ then performs the detection process.

In the manner described above, according to the second embodiment, because an area reflected with a change in the operation information is set to the captured image 40 based on the operation, detection parameters used in detecting the object area can be selected appropriately. Hence, the object areas can be detected more accurately from the entire captured image 40.

When the image acquiring unit 200, the operation information acquiring unit 201, the detection parameter setting unit 202, and the detector 203 included in the detecting device 20, or the operation information acquiring unit 201, the detection parameter setting unit 202, the detector 203′, and the detection parameter target area determining unit 204 included in the detecting device 20′ are implemented as a computer program operating on a CPU, the computer program is implemented as a detection program stored in the ROM or the like in advance, and executed on the CPU. The detection program is provided, as a computer program product, in a manner recorded in a computer-readable recording medium such as a compact disc (CD), a flexible disk (FD), or a digital versatile disc (DVD), as an installable or executable file.

The detection program executed by the detecting device 20 (the detecting device 20′) according to the embodiments may be stored in a computer connected to a network such as the Internet, and may be made available for download over the network. The detection program executed by the detecting device 20 (the detecting device 20′) according to the embodiments may also be provided or distributed over a network such as the Internet. The detection program according to the embodiments may be embedded and provided in a ROM, for example.

The detection program executed by the detecting device 20 (the detecting device 20′) has a modular configuration including the units described above (the image acquiring unit 200, the operation information acquiring unit 201, the detection parameter setting unit 202, and the detector 203 in the detecting device 20, for example). As the actual hardware, by causing the CPU to read the detection program from a storage medium such as a ROM and to execute the detection program, the units described above are loaded onto a main memory such as a RAM, whereby causing the image acquiring unit 200, the operation information acquiring unit 201, the detection parameter setting unit 202, and the detector 203 to be generated on the main memory.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A detecting device mounted on a moving object, the detecting device comprising:
an image acquiring unit configured to acquire an image;
an operation information acquiring unit configured to acquire an operation in the moving object, the operation affecting the image;
a setting unit configured to set a parameter based on the operation; and
a detector configured to detect an object area from the image by performing a detection process in accordance with the set parameter.

2. The device according to claim 1, wherein
the detector is configured to perform the detection process using a detection algorithm indicating steps of performing the detection process, a detection model indicating a type of the detection process, and a threshold that is used to detect the object area with the detection model, and
the setting unit is configured to set the parameter including the detection algorithm, the detection model, and the threshold to the detector.

3. The device according to claim 2, wherein the detector is configured to perform the detection process based on one of a first detection algorithm that performs a process of adjusting luminance of the image before detecting the object area, a second detection algorithm that performs a process of removing defocus from the image before detecting the object area, and a third detection algorithm that performs a process of removing blur from the image before detecting the object area, the first algorithm, the second algorithm, and the third algorithm being included in at least one of the parameter.

4. The device according to claim 2, wherein the detector is configured to perform the detection process based on one of a first detection model that detects the object area with a process corresponding to luminance of the image, a second detection model that detects the object area using the image with a part thereof masked, a third detection model that detects the object area from the image with defocus, and a fourth detection model that detects the object area from the image with blur,
the detector is configured to perform the detection process based on at least one of the first detection model, the second detection model, the third detection model, and the forth detection model, the first detection model, the second detection model, the third detection model and the forth detection model being included in the parameter.

5. The device according to claim 1, wherein
the operation acquired by the operation information acquiring unit is assigned in advance with priority based on how much the operation affects the image depending on a type of the operation, and
the setting unit is configured to set the parameter to the detector based on an operation with the highest priority, among those acquired by the operation information acquiring unit.

6. The device according to claim 1, wherein
the setting unit is configured to further set a target area to the image correspondingly to the operation, and
the detector is configured to perform the detection process to the target area, using a parameter set to the setting unit.

7. The device according to claim 1, wherein the operation information acquiring unit is configured to acquire at least one of an operation of turning on and off lights, an operation of wipers, a travelling speed, a braking amount, a steering operation, and an operation of turning on and off blinkers, as the operation.

8. The device according to claim 1, wherein the image acquiring unit is configured to acquire, as the image, a captured image obtained by an image capturing device.

9. A detection method performed by a detecting device mounted on a moving object, the method comprising:
acquiring an image;
acquiring an operation in the moving object, the operation affecting the image;
setting a parameter based on the operation; and
detecting an object area from the image by performing a detection process in accordance with the set parameter.

10. A computer program product comprising a computer-readable medium containing a program executed by a computer that executes a detection method performed by a detecting device mounted on a moving object, the program causing the computer to execute
acquiring an image;
acquiring an operation in the moving object, the operation affecting the image;
setting a parameter based on the operation; and
detecting an object area from the image by performing a detection process in accordance with the set parameter.
